(19) United States
(12) Patent Application Publication
(10) Pub. No.: US 2022/0292340 A1
(43) Pub. Date: Sep. 15, 2022

(54) IDENTIFYING TRENDS USING EMBEDDING DRIFT OVER TIME

(71) Applicant: Capital One Services, LLC, McLean, VA (US)

(72) Inventors: Antonia GOGOGLOU, Mountain View, CA (US); Jonathan RIDER, McLean, VA (US); Brian NGUYEN, Chantilly, VA (US); Christopher BRUSS, Washington, DC (US)

(73) Assignee: Capital One Services, LLC, McLean, VA (US)

(21) Appl. No.: 17/198,624

(22) Filed: Mar. 11, 2021

(51) Int. Cl. G06N 3/08; G06K 9/62

(52) U.S. Cl. CPC G06N 3/08; G06K 9/6296; G06K 9/6215; G06K 9/6232

(57) ABSTRACT

Systems, methods, and computer program products for identifying trends in behavior using embedding drift. A graph neural network may receive a network graph includes a plurality of nodes, the network graph based on a plurality of transactions for a first time interval, each transaction associated with at least one account. An embedding layer of the neural network may generate, based on the network graph, a respective embedding vector for each of the nodes. The neural network may receive a second embedding vector for each of the nodes. The neural network may determine, based on the embedding vectors and the second embedding vectors, a respective drift for each node. The neural network may determine that the drift of a first node is greater than the drift of a second node, and performing a processing operation on a first account corresponding to the first node.

### TECHNICAL FIELD

Embodiments disclosed herein relate to machine classification architectures. More specifically, embodiments disclosed herein relate to machine classification architectures for identifying trends using embedding drift over time.

### BACKGROUND

Financial transactions represent a large network of relationships between entities. These entities can include relationships between merchants and account holders, accounts and other accounts, financial institutions and other financial institutions, and the like. Such transaction networks are very high dimensional (e.g., millions or billions of entities) yet are simultaneously very sparse, as any given entity usually interacts with a small subset of other entities. Using these types of networks in machine learning is difficult because of the high-dimensionality and sparsity properties, and conventional machine learning models cannot scale to learn weights for the full dimensions of the network. Conventional solutions may include statistic aggregation that simplifies the transactions. However, doing so poses problems with trend analysis, as information loss may occur, and the position of a given entity may be oversimplified.

### BRIEF SUMMARY

Embodiments disclosed herein include systems, methods, and computer program products for identifying trends using embedding drift over time. In a variety of embodiments, a method includes receiving, by a graph neural network, a network graph includes a plurality of nodes, the network graph based on a plurality of transactions for a first time interval, each transaction associated with at least one account of a plurality of accounts, each node of the plurality of nodes associated with a respective one of the plurality of accounts, generating, by an embedding layer of the neural network based on the network graph, a respective embedding vector for each of the plurality of nodes, the embedding vectors for the first time interval, receiving a respective second embedding vector for each of the plurality of nodes, the second embedding vectors based on a second time interval, the second time interval prior to the first time interval, determining, based on the embedding vectors for the plurality of nodes and the second embedding vectors for the plurality of nodes, a respective drift for each node, determining that the drift of a first node of the plurality of nodes is greater than the drift of a second node of the plurality of nodes, and performing a processing operation on a first account corresponding to the first node based on the determination that the drift of the first node is greater than the drift of the second node. A variety of embodiments are described and claimed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 4 illustrates an aspect of the subject matter in accordance with one embodiment.

FIG. 5 illustrates a routine 500 in accordance with one embodiment.

FIG. 6 illustrates a routine 600 in accordance with one embodiment.

FIG. 7 illustrates a routine 700 in accordance with one embodiment.

FIG. 8 illustrates a computer architecture 800 in accordance with one embodiment.

### DETAILED DESCRIPTION

Embodiments disclosed herein provide techniques for identifying trends in account behavior based on embedding drift over time. Generally, embodiments disclosed herein may use a graph neural network to generate embeddings for accounts based on a transaction graph reflecting transactions over different points in time (e.g., daily time steps, weekly time steps, monthly time steps, etc.). The accounts may be any type of accounts for any type of entity, such as customer (or consumer) accounts, merchant accounts, creditor accounts, and the like. Embodiments disclosed herein may compute the drift for the embeddings based on the different node embeddings for two or more different time steps. The drift may be defined by any suitable metric, such as cosine similarity of two embeddings that measure the drift in terms of angle, Euclidean distance between two embeddings that measure the drift in terms of magnitude, and the like. Furthermore, by defining metrics such as the drift of an entity normalized over the average drift of all entities between two different time steps, embodiments disclosed herein may identify and/or flag the accounts that have changed the most over time. One or more processing operations may be performed on the accounts of the identified accounts, such as fraud analysis, credit line adjustment, etc. By repeating this process multiple times, embodiments disclosed herein may produce a time series of normalized drift and the characteristics (e.g., shape, curvature, gradient) of this trajectory may be used to determine global trends across different groups of accounts (e.g., retail merchants, food service merchants, customers, online retailers, etc.).

Furthermore, embodiments disclosed herein may perform time series clustering of the normalized drifts in the context of dynamically evolving graphs (e.g., the graphs evolve as millions or more new transactions may occur on a daily basis). Embodiments disclosed herein may use the result of the time series clustering to group together accounts that follow similar trajectories (and therefore follow similar transactional patterns). Applications may use the groupings and/or clusterings to train machine learning models independently for each group to fully exploit the similarities between them and/or by incorporating the time series itself as a differentiating feature in the applications. Examples of such applications include risk analysis applications, targeted marketing applications, fraud analysis applications, and the like.

Advantageously, embodiments disclosed herein provide techniques to identify trends in account behavior using machine learning. By categorizing accounts based on a dynamic trend aggregated in a dense latent space (e.g., an embedding space for multi-dimensional embedding vectors), embodiments disclosed herein provide improvements to conventional techniques, which categorized accounts statically at a given point in time. Further still, embodiments disclosed herein present techniques to group accounts and identify behaviors using a macroscopic view of transactional patterns over multiple snapshots of a transaction graph, where each snapshot corresponds to a different time interval. Therefore, using the techniques of the disclosure, computing systems may identify trends in account behavior more accurately than conventional techniques. Doing so improves system performance by increasing the accuracy of the output.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

In the Figures and the accompanying description, the designations “a” and “b” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

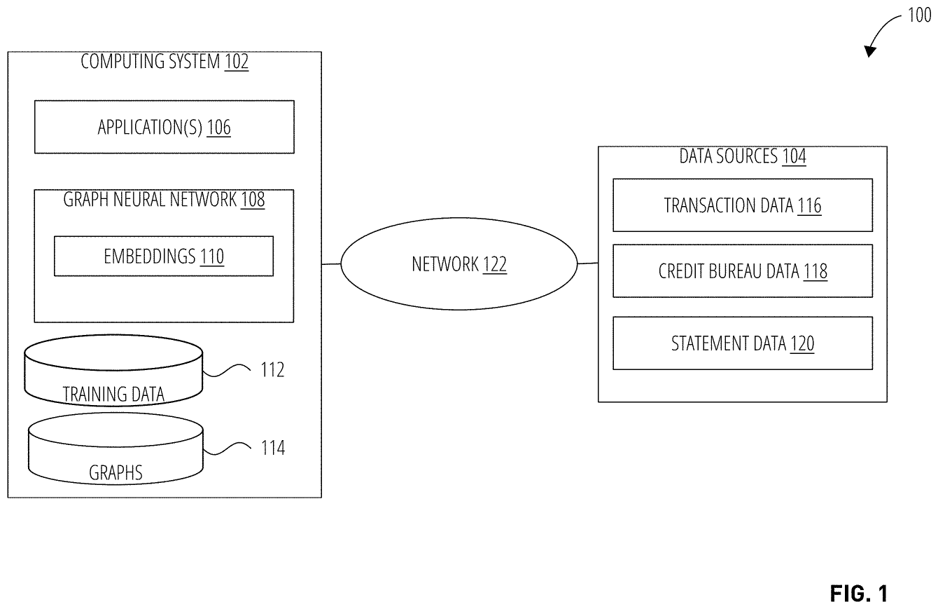

FIG. 1 depicts a schematic of an exemplary system 100, consistent with disclosed embodiments. As shown, the system 100 includes at least one computing system 102 and one or more data sources 104 communicably coupled via a network 122. The computing system 102 and data sources 104 are representative of any type of computing system or device, such as a server, compute cluster, cloud computing environment, virtualized computing system, and the like. The data sources 104 are further representative of entities such as databases, files, credit reporting bureaus, account statements, and transaction logs. Collectively, the data sources 104 provide transaction data 116, credit bureau data 118 (e.g., credit reports), and statement data 120 (e.g., bank statements, credit card statements, etc.) that may be used as training data 112 to train the graph neural networks 108. Although a graph neural network 108 is used as a reference example herein, the disclosure is applicable to any other type of machine classifier architecture, or combination of machine classifier architectures. Examples of machine classifier architectures include, but are not limited to, linear classifiers, logistic regression models, support vector machines, quadratic classifiers, kernel estimators, decision trees, and random forests.

The data provided by the data sources 104 may be updated periodically as new transactions, loans, and/or credit reports are processed (e.g., hourly, daily, weekly, etc.). Furthermore, as new data from the transaction data 116, credit bureau data 118, and statement data 120 becomes available, the new data may be used in runtime operations, e.g., to update the embeddings 110, identify trends, risk analysis, fraud analysis, or any other type of processing operation.

The transaction data 116 is raw transaction data describing a plurality of card-based transactions, such as credit card transactions, debit card transactions, gift card transactions, and the like. The use of a particular payment type should not be considered limiting of the disclosure, as the disclosure is equally applicable to all types of transaction data. In many embodiments, the transaction data 116 is provided by the issuer of the cards used to complete each transaction. The transaction data 116 may include any number and type of attributes describing a given transaction. For example, the transaction data 116 may include at least an account identifier (e.g., a customer account number, a customer credit card number, a merchant account number, etc.), a merchant identifier (e.g., a merchant name), a timestamp associated with the transaction, an amount of the transaction, and a location of the transaction, among many other data attributes. As such, the data space of the transaction data 116 is high-dimensional, including data describing millions (or more) of unique accounts and merchants.

The transaction data 116 defines relationships between entities, such as customer accounts and merchants, creditors and lenders, and the like. For example, when a customer purchases an item from a merchant, a relationship is defined. Similarly, when a merchant transacts with another merchant, a relationship is defined. Thus, the transaction data 116 can be leveraged to expose a variety of different attributes of the accounts, such as account activity, customer preferences, similarity to other accounts, and the like. However, the transaction data 116 is sparse, as any given customer account (which includes merchant accounts that perform transactions with other merchants) interacts with a small fraction of merchants. Similarly, any given merchant may interact with a fraction of the customer accounts. Therefore, the transaction data 116 implicitly creates a bipartite graph between accounts. This sparse, high-dimensional space is very difficult to use for desirable analysis purposes. Advantageously, however, the system 100 is configured to overcome these limitations and leverage the transaction data 116 to provide useful analytical tools, thereby exposing new functionality based on the transaction data 116 in its entirety.

The credit bureau data 118 is representative of any type of credit reporting data, including credit reports based on a “hard” credit pull and credit reports based on “soft” credit pulls. The hard credit pulls may provide more information than the soft credit pulls. Generally, each type of credit report may reflect loans received by the corresponding user, the lenders, the amounts of each loan, the type of each loan, the status of each loan (e.g., defaulted, paid in full, partially paid, current, etc.). The statement data 120 may include periodic statements describing one or more accounts, such as monthly checking account statements, monthly credit card statements, etc. The statement data 120 may further reflect whether balances have been paid, transactions, late fees, etc. In some embodiments, the statement data 120 is reflected in the credit bureau data 118.

An application 106 may receive the transaction data 116 of prior transactions from the data sources 104 to generate one or more graphs 114 of the transactions using one or more extract transform load (ETL) functions. A graph 114 may generally include a plurality of nodes and a plurality of edges, where each edge connects two of the nodes. The ETL functions may generally include standardizing the transaction data 116 according to one or more formats, and assigning each unique entity (e.g., customer accounts and/or merchant accounts) a unique identifier. Similarly, the application 106 may receive the credit bureau data 118 and/or statement data 120 to generate a graph 114 reflecting loans (or extensions of credit) using one or more ETL functions. Doing so may standardize the credit bureau data 118 and/or statement data 120 according to one or more formats, and assigning each unique entity (e.g., creditors/lenders and/or debtors/borrowers) a unique identifier. In some embodiments, a single graph 114 may be generated to reflect transactions, loans, or any other type of relationship. In a variety of embodiments, multiple different graphs 114 may be generated.

Each node in a graph 114 may represent an entity (e.g., a customer account, a merchant account, financial institution, etc.), and edges may represent a relationship (e.g. a purchase, a loan, payment, default, or any other transaction) between two entities (e.g., a buyer of a product and a seller of the product). An edge between two nodes in the graphs 114 may include a weight, which may represent attributes such as an amount of a loan, an amount of one or more purchases, etc. Each node may further include an instance of an embedding vector 110 that represents a plurality of features of the entity represented by the node.

The transaction data 116, credit bureau data 118, and statement data 120 collectively reflect a plurality of different attributes of customers, purchasers, sellers, borrowers, creditors, transactions, loans, accounts, and the like. However, each data source may not provide a complete set of attributes. For example, a credit report from the credit bureau data 118 may reflect that a customer has paid off their mortgage in full. However, the transaction data 116 may not reflect that the customer has paid off their mortgage. As such, from the data sources 104, information that should be used when making credit decisions and/or modifying credit limits may inadvertently not be considered. Advantageously, however, embodiments disclosed herein provide machine learning systems that herein consider all relevant data, e.g., transaction data 116, credit bureau data 118, and statement data 120.

In many embodiments, the transaction data 116, credit bureau data 118, and/or statement data 120 are used as training data 112 to train the graph neural networks 108 using graph embedding techniques. Examples of graph embedding techniques are included in U.S. patent application Ser. No. 16/246,911, filed Jan. 14, 2019, and U.S. patent application Ser. No. 16/857,780, filed Apr. 24, 2020. Each of the aforementioned patent applications is incorporated by reference herein in its entirety. In some embodiments, the graph embedding techniques include training the graph neural network 108 using negative samples, e.g., a plurality of negative entity pairs not present in the network graph 114. The negative entity pairs may comprise artificially generated relationships between each entity in the negative entity pair (e.g., a negative entity pair may include customer and a merchant, where the customer did not make a purchase with the merchant).

More generally, in an unsupervised manner, the graph embedding techniques capture periodic snapshots of the transactions in the transaction data 116 to learn a vector representation, e.g., an embedding vector 110, of every account based on their transactions. Generally, doing so causes customers that frequently shop at similar merchants to be assigned embedding vectors 110 that point in similar directions (e.g., have similar embedding values). Once the embedding vectors 110 are learned, the embeddings 110 may be used as features in a model. For example a first graph neural network 108-1 may be a credit line model to determine an optimal credit limit for the user. As another example, a second graph neural network 108-2 may be used to determine whether an account is fraudulent, or subject to fraudulent activity. In some embodiments, a supervised learning approach may be used. For example, a graph neural network 108-3 may implement neighborhood aggregation to gather information about a given node (e.g., a customer or a merchant) based on which other nodes (e.g., other customers and/or merchants) the node is connected to. Using the neighborhood aggregation, the graph neural network 108-2 may learn to assign embedding vectors 110 to each node that minimize some prediction error.

As stated, during the training of any of the graph neural networks 108, an embeddings vector (or layer) 110 of the graph neural network 108 is generated. In a variety of embodiments, an embedding vector 110 (also referred to as an “embedding”, or “embeddings”) is an n-dimensional lookup table of floating point numerical values, e.g., a vector of floating point numerical values. In such embodiments, each unique entity ID (e.g., customer ID and merchant ID, or customer ID and lender ID, etc.) in the respective graphs 114 is assigned a unique identifier corresponding to a row in the lookup table, such that each unique entity is represented in the embeddings vector 110. In some embodiments, the embeddings 110 are initialized with initial values, which may be randomly assigned.

The embeddings 110 may generally reflect the current state of each corresponding node in a given graph 114 at a given time. During training, the graph neural network 108 may generally learn relevant features useful in generating a prediction, e.g., whether to extend credit, whether to increase a credit limit, initiate fraud analysis, money laundering analysis, etc. Similarly, the graph neural network 108 may further determine which features are not relevant in generating the prediction during training.

Once trained, the graph neural network 108 may determine the drift of the embeddings 110 over different time intervals. For example, the embeddings 110 may be generated at periodic time intervals, such as monthly time intervals. Therefore, the embeddings 110 generated by the graph neural network 108 may reflect relevant information useful in identifying trends for different accounts. For example, an application 106 and/or a graph neural network 108 may determine a drift between two or more embeddings 110 captured at two or more time intervals. The drift may be based on any suitable metric. For example, in many embodiments, the drift may be a distance between embeddings 110 in a vector space of the embeddings 110. The vector space may be any n-dimensional space corresponding to the dimension of the embeddings 110. For example, if an embedding vector 110 has 100 dimensions, the vector space is a space of 100 dimensions. Therefore, the distance may be computed as a difference between the embedding vectors 110 at a first time step and a second time step, different than the first time step. The difference may therefore be a vector of the same dimension as the embedding vectors 110. In many embodiments, the drift may be based on a cosine similarity between the embedding vectors 110 at different time steps. Cosine similarity generally measures the similarity between two vectors, e.g., by computing the cosine of the angle defined by the two vectors. For example, the cosine of an angle defined by embedding vector 110 for time step t=1 and an embedding vector 110 for a time step t=2 may produce the cosine similarity of the two vectors.

Furthermore, embodiments disclosed herein may determine drift (based on distance and/or cosine similarity) over a plurality of time steps. Doing so may produce a time series of normalized drift, and the characteristics (e.g., shape, curvature, gradient, etc.) of the normalized drift may reveal global trends across groups of accounts and/or groups of merchants. Furthermore, embodiments disclosed herein may perform time series clustering on the groups of accounts and/or groups of merchants. Generally, the clustering may group together accounts, merchants, or any other entity that follows similar drift trajectories in the time series. In some embodiments, the clustering may indicate that the entities follow similar transactional patterns. Furthermore, in some embodiments, the graph neural network 108 may generate predictions for future time series (e.g., predict the embeddings 110 for the next time step before the data is available for the next time step).

Advantageously, the applications 106 may use the drift time series data for any number of purposes, such as training new models independently using the time series data for the group to fully exploit the similarities between the groups. As another example, the applications 106 may incorporate the time series drift data as a differentiating feature, e.g., in fraud analysis, computing updated credit limits, determining whether to extend credit, etc. More generally, the applications 106 and/or models may use the time series of drift data for any type of processing operation, such as predicting future embeddings 110, predicting fraud, budgeting predictions, etc. For example, the graph neural network 108 and/or an application 106 may predict the embeddings 110 and/or the drift of the embeddings 110 at a future time, e.g., at a future time interval, based on previous time intervals.

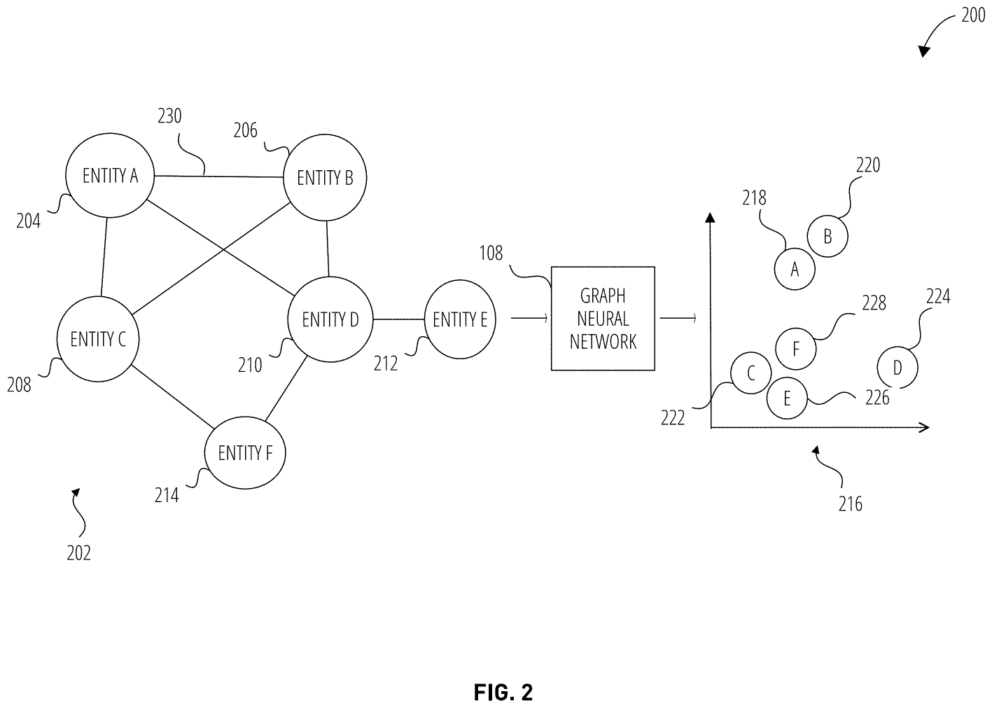

FIG. 2 is a schematic 200 illustrating aspects of the disclosure. The schematic 200 depicts an example network (or transaction) graph 202 that is processed by a graph neural network 108. The graph 202 may correspond to one of the graphs 114 generated based on transaction data 116, credit bureau data 118, and/or statement data 120. As shown, the graph 202 includes nodes for an entity A 204, an entity B 206, an entity C 208, an entity D 210, an entity E 212, an entity F 214. As stated, each node 204, 206, 208, 210, and 212 include an embedding vector 110 (not pictured). The edges (or connections) between the nodes in the graph 202 reflect a relationship between the corresponding entities. For example, the connection 230 between the nodes for entity A 204 and entity B 206 may reflect that entity A (e.g., a customer) purchased an item from entity B 206 (e.g., a merchant). In some embodiments, the connection 230 or other connections may be directed, e.g., from entity A to entity B.

The graph neural network 108 may receive the graph 202 to generate and/or update the embeddings 110 for each entity A-F, e.g., over two or more time steps. The plot 216 in FIG. 2 may reflect a drift of the embeddings 110 for entities A-F computed by the graph neural network 108. Although depicted as a two-dimensional plot 216, the plot 216 may any number of dimensions, such as the number dimensions of the embeddings 110. As shown, the plot 216 includes point 218 for entity A, point 220 for entity B, a point 222 for entity C, a point 224 for entity D, a point 226 for entity E, and a point 228 for entity F. The drift reflected in the plot 216 may be based on Euclidean distance and/or cosine similarities of the embeddings 110.

In some embodiments, the graph neural network 108 may identify entities based on the computed drift. For example, if the drift of entity A 204 exceeds a threshold, the graph neural network 108 may flag the account associated with entity A 204, and perform one or more processing operations on the account associated with entity A 204. The processing operations include any type of processing operation for the account, such as fraud analysis, credit limit modification, initiating a monitoring process on the account, risk analysis, budget modification, or modifying a forecast for the account.

In some embodiments, the graph neural network 108 identifies entities based on the drift of a group of entities. For example, the plot 216 may plot the drift of each entity A-F. As shown, doing so produces three groups of entities, namely a first group including entities A and B, a second group including entities C, E, and F, and a third group including entity D. In some embodiments, the graph neural network 108 defines a neighborhood of entities as one or more entities whose positions in the plot 216 are within a predefined distance.

Generally, the graph neural network 108 may use the neighborhood to further refine the drift analysis. For example, in some embodiments, the graph neural network 108 may identify, or flag, an entity based on the entity having the greatest drift (based on Euclidean distance and/or cosine similarity) in its neighborhood. For example, if entity B has a drift that is greater than that of its neighbor entity A in the plot 216, the graph neural network 108 may flag or otherwise identify the account associated with entity B and perform one or more processing operations on the account associated with entity B. For example, because entity B has greater drift than entity A, one or more processing operations may reveal additional insights on the account associated with entity B. For example, by processing the account associated with entity B, an application 106 and/or graph neural network 108 may identify fraudulent activity. As another example, the applications 106 and/or graph neural network 108 may determine to reduce a line of credit for entity B based on the drift, while not modifying the line of credit for entity A (due to entity A not having the greatest drift in its neighborhood).

Similarly, if entity E has the greatest drift relative to entities C and F, the graph neural network 108 and/or an application 106 may flag the account associated with entity E, and cause one or more processing operations to be performed on the account associated with entity E. For example, the processing operation may lower a budget forecast for entity E to reflect the greater drift of the embeddings 110 for entity E. In such an example, other processing operations may be performed on the account, such as denying a request for a credit increase, etc.

In some embodiments, the graph neural network 108 may apply a Kalman filter (also referred to as a linear quadratic estimation) to the time series, e.g., to verify that any detected drift is meaningful. Generally, the Kalman filter may estimate a joint probability distribution of the drift and/or embeddings 110 over each time interval in the time series. The joint probability distribution may include a distribution of a plurality of values for the drift and/or embeddings 110. In some embodiments, the training of the graph neural network 108 using training data 112, may introduce some random rotation in the embeddings 110 and/or computed drift. However, some changes in the values of the embeddings 110 are not meaningful. The application of a Kalman filter may remove the insignificant changes in the embeddings 110 and produce a smoothed out version of the embeddings 110 and/or drift over time. The smoothed out version of the embeddings 110 and/or drift may be used to identify accounts for processing operations. For example, the plot 216 may be based on the smoothed embeddings 110 and/or drift subsequent to applying the Kalman filter. However, the entity having the largest drift based on the smoothed time series data may be flagged and processed as described above (e.g., entity B for having a greater drift than entity A, etc.). Advantageously, by applying the Kalman filter, an entity may be placed in a different neighborhood. For example, in FIG. 2, entity D has no neighbors within a predefined distance in the plot 216. However, by applying the Kalman filter, entity D may join a group, or cluster, of entities, such as the group including entities A and B.

Moreover, the techniques of the disclosure allow for identifying trends within a group of entities. For example, the drift of the group of nodes A and B may be monitored over time. In doing so, embodiments disclosed herein may determine whether an entity changes in accordance with its own neighborhood. For example, during the global pandemic of 2020, a group of retail merchants may have seen a downtrend in customer spending. Furthermore, each retail merchant may be analyzed to determine whether it experienced the same downtrend as its group during the pandemic.

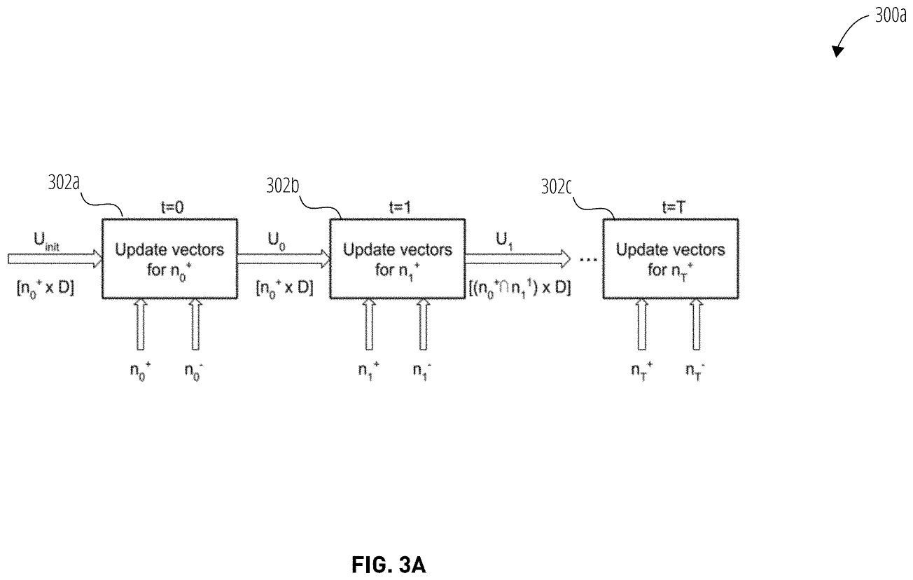

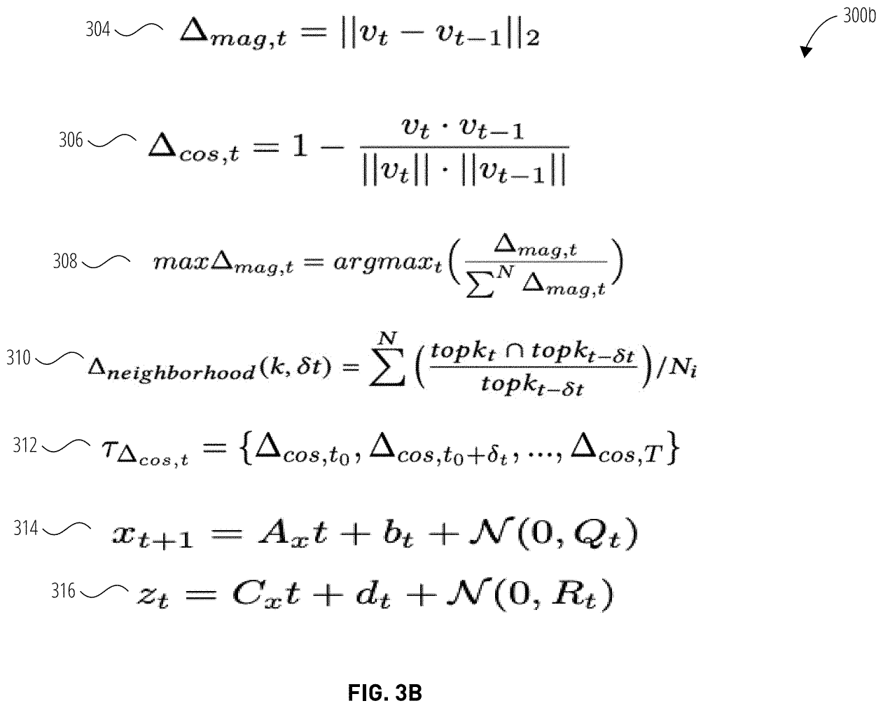

FIG. 3A is a schematic 300a illustrating an embodiment of generating and/or updating embeddings 110 over a plurality of time intervals. As shown, the schematic 300a comprises a block 302a, a block 302b, and a block 302c. Each block 302a-302c may generally reflect a distinct time interval, such as time interval t=0, t=1, and t=T (where T is any positive integer greater than 1), respectively. At each time interval, the graph neural network 108 may update the embeddings 110 for each entity in the graphs 114. Based on the embeddings 110 at a given time interval, embodiments disclosed herein may quantify the drift over time.

FIG. 3B is a schematic 300b illustrating techniques for quantifying drift based on the embeddings 110. More specifically, schematic 300b depicts an equation 304, an equation 306, an equation 308, an equation 310, an equation 312, an equation 314, and an equation 316. Generally, equation 304 may be used to compute the similarity (represented as Δ_{mag,t}) based on distance between embeddings 110 at a first time step t and a second time step t−1, where time step t is subsequent to time step t−1. In equation 304, vₜ, vₜ₋₁ correspond to the embedding vectors 110 at time steps t and t−1, respectively. Equation 306 may be used to compute the cosine similarity (represented as Δ_{cos,t}) of the embeddings 110 at time steps t and t−1. In equation 306, vₜ, vₜ₋₁ correspond to the embedding vectors 110 at time steps t and t−1, respectively. Equation 308 may be used to identify the entity having the maximum distance between embeddings 110. In equation 308, the Δ_{mag,t} corresponds to the similarity computed based on equation 304, argmaxₜ corresponds to a maximum value, and Σ^{N} corresponds to the sum of a plurality of similarity values computed based on equation 304.

Equation 310 may generally be used to define a neighborhood of nodes (represented as Δ_{neighborhood}(k, ∂t)), e.g., as the nodes having the highest cosine similarity around a target node k for a time window ∂t. In equation 310, topkₜ corresponds to the top k nodes having the highest cosine similarity at time interval t, topk_{t-dt} corresponds to the top k nodes having the highest cosine similarity at time interval t−∂t, and N represents a node. Equation 312 generally defines a time series τΔ_{cos,t} which includes the computed cosine similarities Δ_{cos,t} computed according to equation 306 over a plurality of time intervals. The time series, or series of shifts in the drift of the embeddings 110, may be viewed as a state space model. By decomposing the time series into its constituent components, embodiments disclosed herein may identify the effects of the trend component, and determine the expected random component that arises from the rotation of the embedding space of the embeddings 110 after multiple rounds of training to generate multiple instances of the embeddings 110 (e.g., embeddings 110 for each time interval).

Equations 314-316 may include some or all of the operations used to apply a Kalman filter smoothing on an element-wise shift to compute the components of the next time step as a linear combination of predicted and actual embeddings 110 values. In some embodiments, the Kalman filter assumes the series contains some level of Gaussian noise or inaccuracy. More generally, equations 314-316 may be used to estimate a probability distribution P(xt|z=:T−1) for a given time series. Equation 314 may generally be used to compute a value xₜ₊₁ for time t+1 based on a state transition model A_{t×t} applied to a previous time t, a control bₜ, and a process noise based on a normal distribution N(0,Qₜ) with covariance Qₜ. Equation 316 may generally be used to compute an observation of the state zₜ at time t based on an observation model C_{t×t}, a control dₜ, and an observation noise based on a normal distribution N(0,Rₜ) with covariance Rₜ.

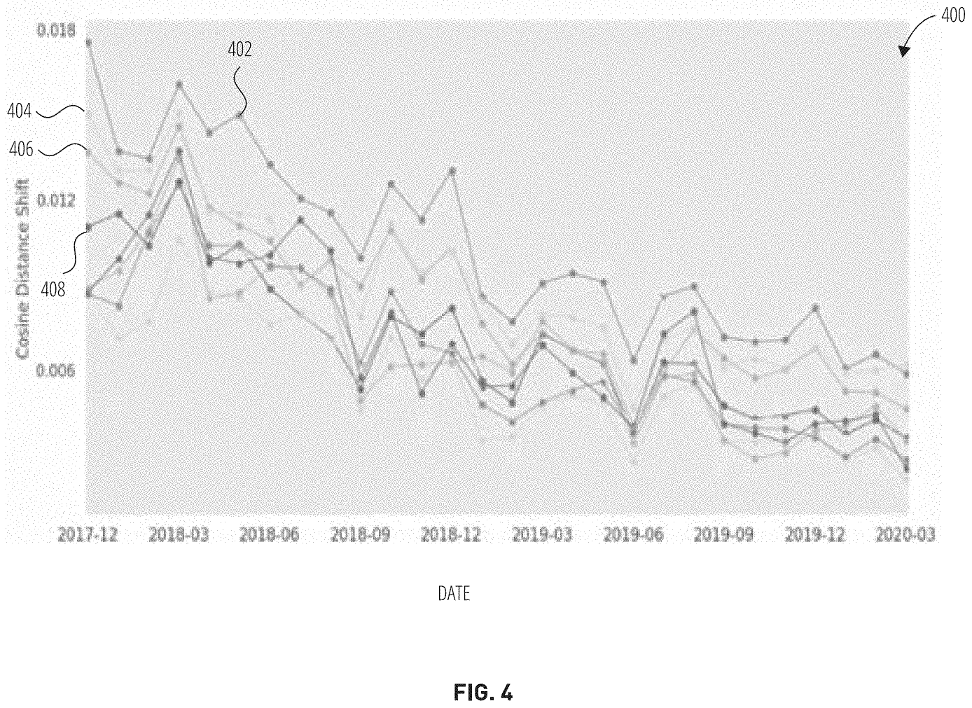

FIG. 4 illustrates a chart 400 reflecting example processing operations performed by the graph neural network 108 over a plurality of time intervals. Generally, the chart 400 plots embedding drift (or shift) measured by cosine similarity over time, e.g., a time series of embedding drift. The chart 400 comprises a line 402, a line 404, a line 406, and a line 408, where each line corresponds to a respective entity, or group of entities. For example, line 402 may correspond to service entities, line 404 may correspond to healthcare entities, line 406 may correspond to travel entities, and line 408 may correspond to retail entities. Generally, the chart 400 may reveal different trends across each group of entities. In some embodiments, the graph neural network 108 may determine to flag all entities in each group based on the chart 400, as the drift of each line 402, 404, 406, 408 is trending downward (e.g., based on the economic impact of the global pandemic in 2020). In such embodiments, the graph neural network 108 may process each associated account for fraud detection, risk analysis, credit decisioning, credit limit adjustment, etc.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

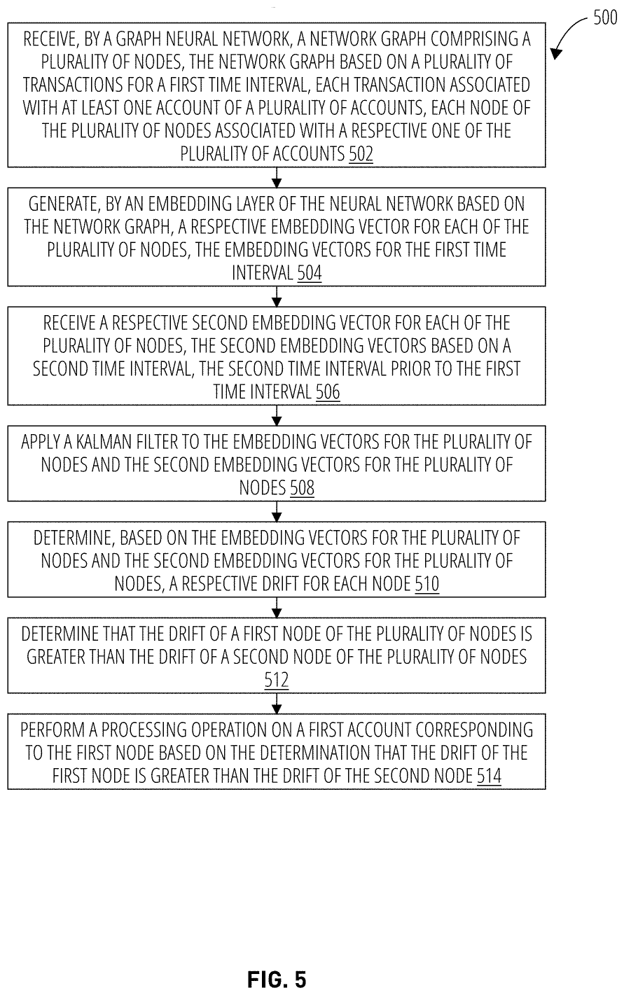

FIG. 5 illustrates an embodiment of a logic flow, or routine, 500. The logic flow 500 may be representative of some or all of the operations executed by one or more embodiments described herein. For example, the logic flow 500 may include some or all of the operations to identify trends in account behavior using the drift of embeddings 110 over different time steps. Embodiments are not limited in this context.

In block 502, routine 500 receives, by a graph neural network 108, a network graph 114 comprising a plurality of nodes, the network graph based on a plurality of transactions for a first time interval, each transaction associated with at least one account of a plurality of accounts (or entities), each node of the plurality of nodes associated with a respective one of the plurality of accounts (and/or associated entity). In block 504, routine 500 generates, by an embedding layer of the graph neural network 108 based on the network graph 114, a respective embedding vector 110 for each of the plurality of nodes, the embedding vectors for the first time interval. In block 506, routine 500 receives a respective second embedding vector for each of the plurality of nodes, the second embedding vectors based on a second time interval, the second time interval prior to the first time interval. In block 508, routine 500 applies a Kalman filter to the embedding vectors for the plurality of nodes and the second embedding vectors for the plurality of nodes.

In block 510, routine 500 determines, based on the embedding vectors for the plurality of nodes and the second embedding vectors for the plurality of nodes, a respective drift for each node. The drift may be based on a distance between the embeddings 110 in the vector space of the embeddings 110. For example, the distance may be computed as a difference between first and second embedding vectors in the vector space. In addition and/or alternatively, the drift may be based on a cosine similarity of the first and second embedding vectors. In block 512, routine 500 determines that the drift of a first node of the plurality of nodes is greater than the drift of a second node of the plurality of nodes. In some embodiments, the routine 500 further determines that the drift of the first node is greater than all other nodes within a predefined distance of the node in an embedding space of the embeddings 110 for each node. In block 514, routine 500 performs a processing operation on a first account corresponding to the first node based on the determination that the drift of the first node is greater than the drift of the second node.

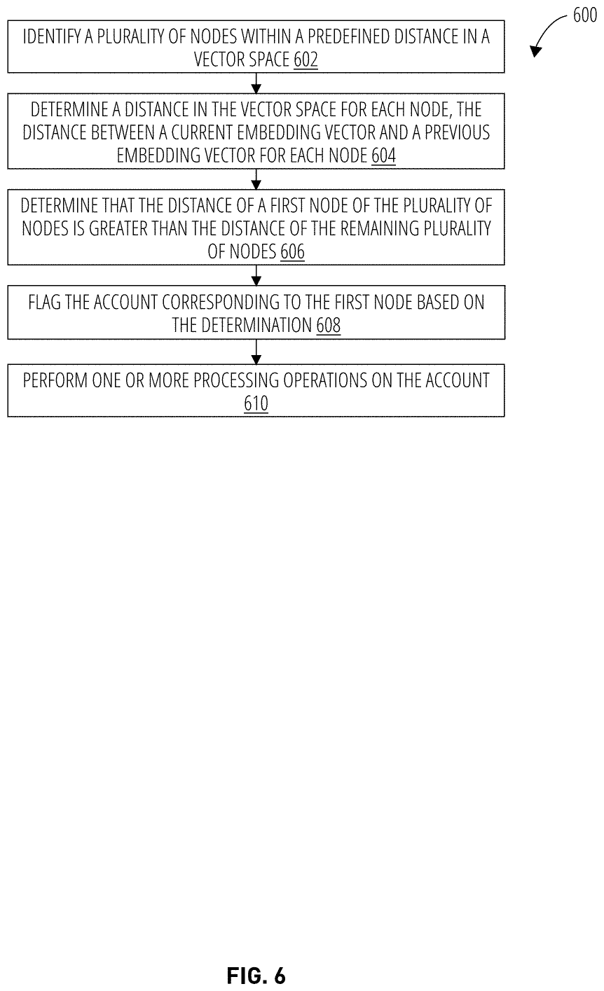

FIG. 6 illustrates an embodiment of a logic flow, or routine, 600. The logic flow 600 may be representative of some or all of the operations executed by one or more embodiments described herein. For example, the logic flow 600 may include some or all of the operations to identify trends in account behavior using the drift of embeddings 110 over different time steps based on a magnitude of the drift. Embodiments are not limited in this context.

In block 602, routine 600 identifies a plurality of nodes within a predefined distance in a vector space. The vector space may be the space of the embeddings 110, e.g., the vector space may have a number of dimensions equaling a number of dimensions of the embeddings 110. In block 604, routine 600 determines a distance, in the vector space and for each node, between a current embedding vector and a previous embedding vector for each node. For example, a first entity (and/or account) represented by one of the nodes may have embedding vectors v1, v2, for a first and second time interval, respectively. The difference may be computed as v2−v1 (where the second time interval is subsequent to the first time interval). In block 606, routine 600 determines that the distance of a first node of the plurality of nodes is greater than the distance of the remaining plurality of nodes. In block 608, routine 600 flags the account corresponding to the first node, e.g., by storing the flag in a record associated with the account in a storage medium. In block 610, routine 600 performs one or more processing operations on the account. The processing operations may include credit line adjustment processing, credit decisioning processing, fraud processing, anomaly detection, budget modification, and the like.

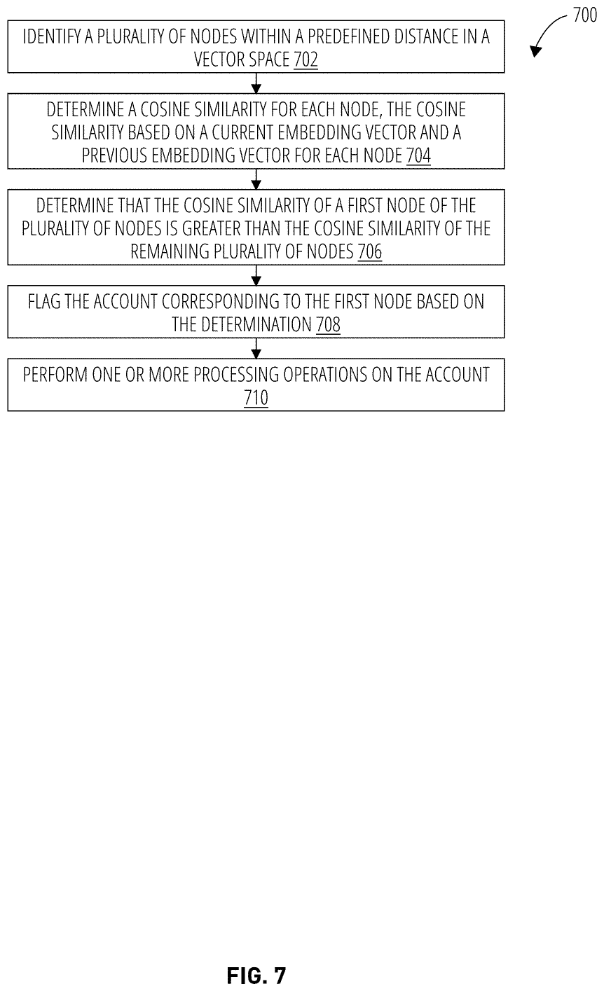

FIG. 7 illustrates an embodiment of a logic flow, or routine, 700. The logic flow 700 may be representative of some or all of the operations executed by one or more embodiments described herein. For example, the logic flow 700 may include some or all of the operations to identify trends in account behavior using the drift of embeddings 110 over different time steps based on an angle, or cosine similarity, of the drift. Embodiments are not limited in this context.

In block 702, routine 700 identifies a plurality of nodes within a predefined distance in a vector space. The vector space may be the embedding space of the embeddings 110. In block 704, routine 700 determines a cosine similarity for each node, the cosine similarity based on a current embedding vector and a previous embedding vector for each node. The cosine similarity may measure the similarity based on an angle between the vectors. In block 706, routine 700 determines that the cosine similarity of a first node of the plurality of nodes is greater than the cosine similarity of the remaining plurality of nodes. In block 708, routine 700 flags the account corresponding to the first node based on the determination, e.g., by storing the flag in a record associated with the account in a storage medium. In block 710, routine 700 performs one or more processing operations on the account. The processing operations may include credit line adjustment processing, credit decisioning processing, fraud processing, anomaly detection, budget modification, and the like.

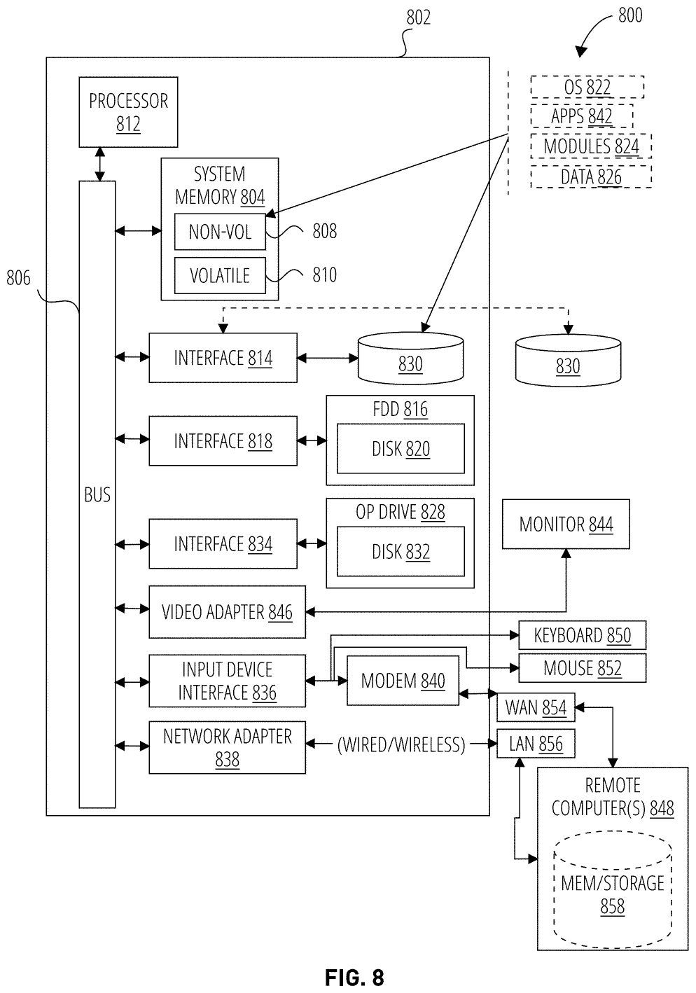

FIG. 8 illustrates an embodiment of an exemplary computer architecture 800 suitable for implementing various embodiments as previously described. In a variety of embodiments, the computer architecture 800 may include or be implemented as part of system 100.

As used in this application, the terms “system” and “component” are intended to refer to a computer-related entity, either hardware, a combination of hardware and software, software, or software in execution, examples of which are provided by the exemplary computing computer architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing computer architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 800.

As shown in FIG. 8, the computer architecture 800 includes a processor 812, a system memory 804 and a system bus 806. The processor 812 can be any of various commercially available processors.

The system bus 806 provides an interface for system components including, but not limited to, the system memory 804 to the processor 812. The system bus 806 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 804 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 804 can include non-volatile 808 and/or volatile 810. A basic input/output system (BIOS) can be stored in the non-volatile 808.

The computer 802 may include various types of computer-readable storage media in the form of one or more lower speed memory units, including an internal (or external) hard disk drive 830, a magnetic disk drive 816 to read from or write to a removable magnetic disk 820, and an optical disk drive 828 to read from or write to a removable optical disk 832 (e.g., a CD-ROM or DVD). The hard disk drive 830, magnetic disk drive 816 and optical disk drive 828 can be connected to system bus 806 the by an HDD interface 814, and FDD interface 818 and an optical disk drive interface 834, respectively. The HDD interface 814 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 808, and volatile 810, including an operating system 822, one or more applications 842, other program modules 824, and program data 826. In a variety of embodiments, the one or more applications 842, other program modules 824, and program data 826 can include, for example, the various applications and/or components of the system 100.

A user can enter commands and information into the computer 802 through one or more wire/wireless input devices, for example, a keyboard 850 and a pointing device, such as a mouse 852. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 812 through an input device interface 836 that is coupled to the system bus 806 but can be connected by other interfaces such as a parallel port, IEEE 1394 serial port, a game port, a USB port, an IR interface, and so forth.

A monitor 844 or other type of display device is also connected to the system bus 806 via an interface, such as a video adapter 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all the elements described relative to the computer 802, although, for purposes of brevity, only a memory and/or storage device 858 is illustrated. The logical connections depicted include wire/wireless connectivity to a local area network 856 and/or larger networks, for example, a wide area network 854. Such LAN and WAN networking environments are commonplace in offices and companies, and facilitate enterprise-wide computer networks, such as intranets, all of which may connect to a global communications network, for example, the Internet.

When used in a local area network 856 networking environment, the computer 802 is connected to the local area network 856 through a wire and/or wireless communication network interface or network adapter 838. The network adapter 838 can facilitate wire and/or wireless communications to the local area network 856, which may also include a wireless access point disposed thereon for communicating with the wireless functionality of the network adapter 838.

When used in a wide area network 854 networking environment, the computer 802 can include a modem 840, or is connected to a communications server on the wide area network 854 or has other means for establishing communications over the wide area network 854, such as by way of the Internet. The modem 840, which can be internal or external and a wire and/or wireless device, connects to the system bus 806 via the input device interface 836. In a networked environment, program modules depicted relative to the computer 802, or portions thereof, can be stored in the remote memory and/or storage device 858. It will be appreciated that the network connections shown are exemplary and other means of establishing a communications link between the computers can be used.

The computer 802is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-7 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A method, comprising:
receiving, by a graph neural network, a network graph comprising a plurality of nodes, the network graph based on a plurality of transactions for a first time interval, each transaction associated with at least one account of a plurality of accounts, each node of the plurality of nodes associated with a respective one of the plurality of accounts;
generating, by an embedding layer of the neural network based on the network graph, a respective embedding vector for each of the plurality of nodes, the embedding vectors for the first time interval;
receiving a respective second embedding vector for each of the plurality of nodes, the second embedding vectors based on a second time interval, the second time interval prior to the first time interval;
determining, based on the embedding vectors for the plurality of nodes and the second embedding vectors for the plurality of nodes, a respective drift for each node;
determining that the drift of a first node of the plurality of nodes is greater than the drift of a second node of the plurality of nodes; and
performing a processing operation on a first account corresponding to the first node based on the determination that the drift of the first node is greater than the drift of the second node.

2. The method of claim 1, wherein the drift is based on a distance in a vector space between the embedding vector and the second embedding vector for the respective nodes.

3. The method of claim 1, wherein the drift is based on a cosine similarity of the embedding vector and the second embedding vector for the respective nodes.

4. The method of claim 1, further comprising prior to determining the drift for each node:
applying a Kalman filter to the embedding vectors for the plurality of nodes and the second embedding vectors for the plurality of nodes.

5. The method of claim 4, further comprising:
generating, by the graph neural network, a third embedding vector for each of the plurality of nodes based on a third time interval, the third time interval subsequent to the first time interval;
determining, based on the embedding vectors for the plurality of nodes and the third embedding vectors for the plurality of nodes, a predicted drift for each node;
determining that the predicted drift of a first node of the plurality of nodes is greater than the predicted drift of a second node of the plurality of nodes; and
performing a processing operation on the first account based on the determination that the predicted drift of the first node is greater than the predicted drift of the second node.

6. The method of claim 1, further comprising:
determining that the drift of the first node is greater than the drift of each of a subset of the plurality of nodes, the subset of the plurality of nodes within a predefined distance of the first node in a vector space for the embedding vectors.

7. The method of claim 1, wherein the processing operation comprises one or more of: (i) performing a fraud analysis on the first account, (ii) modifying a credit limit of the first account, (iii) initiating a monitoring process on the first account, (iv) performing a risk analysis of the first account, (v) modifying a budget of the first account, or (vi) modifying a forecast for the first account.

8. A non-transitory computer-readable storage medium, the computer-readable storage medium including instructions that when executed by a computer processor, cause the processor to:
receive, by a graph neural network, a network graph comprising a plurality of nodes, the network graph based on a plurality of transactions for a first time interval, each transaction associated with at least one account of a plurality of accounts, each node of the plurality of nodes associated with a respective one of the plurality of accounts;
generate, by an embedding layer of the neural network based on the network graph, a respective embedding vector for each of the plurality of nodes, the embedding vectors for the first time interval;
receive a respective second embedding vector for each of the plurality of nodes, the second embedding vectors based on a second time interval, the second time interval prior to the first time interval;
determine, based on the embedding vectors for the plurality of nodes and the second embedding vectors for the plurality of nodes, a respective drift for each node;
determine that the drift of a first node of the plurality of nodes is greater than the drift of a second node of the plurality of nodes; and
perform a processing operation on a first account corresponding to the first node based on the determination that the drift of the first node is greater than the drift of the second node.

9. The computer-readable storage medium of claim 8, wherein the drift is based on a distance in a vector space between the embedding vector and the second embedding vector for the respective nodes.

10. The computer-readable storage medium of claim 8, wherein the drift is based on a cosine similarity of the embedding vector and the second embedding vector for the respective nodes.

11. The computer-readable storage medium of claim 8, wherein the instructions further configure the processor to prior to determining the drift for each node:
apply a Kalman filter to the embedding vectors for the plurality of nodes and the second embedding vectors for the plurality of nodes.

12. The computer-readable storage medium of claim 11, wherein the instructions further configure the processor to:
generate, by the graph neural network, a third embedding vector for each of the plurality of nodes based on a third time interval, the third time interval subsequent to the first time interval;
determine, based on the embedding vectors for the plurality of nodes and the third embedding vectors for the plurality of nodes, a predicted drift for each node;
determine that the predicted drift of a first node of the plurality of nodes is greater than the predicted drift of a second node of the plurality of nodes; and
perform a processing operation on the first account based on the determination that the predicted drift of the first node is greater than the predicted drift of the second node.

13. The computer-readable storage medium of claim 8, wherein the instructions further configure the processor to:
determine that the drift of the first node is greater than the drift of each of a subset of the plurality of nodes, the subset of the plurality of nodes within a predefined distance of the first node in a vector space for the embedding vectors.

14. The computer-readable storage medium of claim 8, wherein the processing operation comprises one or more of: (i) perform a fraud analysis on the first account, (ii) modifying a credit limit of the first account, (iii) initiating a monitoring process on the first account, (iv) performing a risk analysis of the first account, (v) modifying a budget of the first account, or (vi) modifying a forecast for the first account.

15. A computing apparatus comprising:
a processor; and
a memory storing instructions that, when executed by the processor, configure the processor to:
receive, by a graph neural network, a network graph comprising a plurality of nodes, the network graph based on a plurality of transactions for a first time interval, each transaction associated with at least one account of a plurality of accounts, each node of the plurality of nodes associated with a respective one of the plurality of accounts;
generate, by an embedding layer of the neural network based on the network graph, a respective embedding vector for each of the plurality of nodes, the embedding vectors for the first time interval;
receive a respective second embedding vector for each of the plurality of nodes, the second embedding vectors based on a second time interval, the second time interval prior to the first time interval;
determine, based on the embedding vectors for the plurality of nodes and the second embedding vectors for the plurality of nodes, a respective drift for each node;
determine that the drift of a first node of the plurality of nodes is greater than the drift of a second node of the plurality of nodes; and
perform a processing operation on a first account corresponding to the first node based on the determination that the drift of the first node is greater than the drift of the second node.

16. The computing apparatus of claim 15, wherein the drift is based on a distance in a vector space between the embedding vector and the second embedding vector for the respective nodes.

17. The computing apparatus of claim 15, wherein the drift is based on a cosine similarity of the embedding vector and the second embedding vector for the respective nodes.

18. The computing apparatus of claim 15, wherein the instructions further configure the processor to prior to determining the drift for each node:
apply a Kalman filter to the embedding vectors for the plurality of nodes and the second embedding vectors for the plurality of nodes.

19. The computing apparatus of claim 18, wherein the instructions further configure the processor to:
generate, by the graph neural network, a third embedding vector for each of the plurality of nodes based on a third time interval, the third time interval subsequent to the first time interval;
determine, based on the embedding vectors for the plurality of nodes and the third embedding vectors for the plurality of nodes, a predicted drift for each node;
determine that the predicted drift of a first node of the plurality of nodes is greater than the predicted drift of a second node of the plurality of nodes; and
perform a processing operation on the first account based on the determination that the predicted drift of the first node is greater than the predicted drift of the second node.

20. The computing apparatus of claim 15, wherein the processing operation comprises one or more of: (i) perform a fraud analysis on the first account, (ii) modifying a credit limit of the first account, (iii) initiating a monitoring process on the first account, (iv) performing a risk analysis of the first account, (v) modifying a budget of the first account, or (vi) modifying a forecast for the first account, wherein the instructions further configure the processor to:
determine that the drift of the first node is greater than the drift of each of a subset of the plurality of nodes, the subset of the plurality of nodes within a predefined distance of the first node in a vector space for the embedding vectors.
